(19) United States
(12) Patent Application Publication
(10) Pub. No.: US 2010/0109823 A1
(43) Pub. Date: May 6, 2010

(54) MAGNETIC STORAGE SWITCH

(76) Inventor: Johann Hauzenberger, Sinzing (DE)

Correspondence Address: HAYES SOLOWAY P.C., 3450 E. SUNRISE DRIVE, SUITE 140, TUCSON, AZ, 85718, US

(21) Appl. No.: 12/161,550

(22) PCT Filed: Jan. 18, 2007
(86) PCT No.: PCT/DE2007/000085

§ 371 Date: Jul. 18, 2008

(30) Foreign Application Priority Data
Jan. 20, 2006 (DE) 10 2006 002 757.4

(51) Int. Cl. H01H 36/00

(52) U.S. Cl. 335/207

(57) ABSTRACT

Magnetic storage switch with a pole armature which can be rotated about an axis, a first switch disc (A) and a second switch disc (B), wherein the pole armature is provided between these switch discs (A, B) and the pole armature comprises a plurality of magnets which are arranged with respectively alternating polarity in the circumferential direction of the pole armature, characterised in that the switch discs (A, B) comprise magnetisable ring segments in the form of magnetic sheets and the two switch discs (A, B) are rotated relative to one another by approximately one half of the pitch with respect to the ring segments.

### CROSS REFERENCE TO RELATED APPLICATIONS

This application is a continuation-in-part of PCT International Patent Application Serial No. PCT/DE2007/000085, filed Jan. 28, 2007, designating the United States. Priority is also claimed from German Application Serial No. 10 2006 002 757.4 filed Jan. 20, 2006.

### FIELD OF THE INVENTION

The following invention is directed to a magnetic storage switch and especially a magnetic storage switch for use in medium voltage installations.

It is one object to provide a switch, which is able to execute switching proceedings at a very high speed. This object is achieved by the object of the independent claims. Advantageous embodiments are described in the subclaims.

### SUMMARY OF THE INVENTION

A magnetic storage switch according to the invention comprises a pole armature which can be rotated about an axis, a first switch disc and a second switch disc, wherein the pole armature is provided between these switch discs and the pole armature comprises a plurality of magnets which are arranged with respectively alternating polarity in the circumferential direction of the pole armature. According to the invention the switch discs comprise magnetizable ring segments in the form of magnetic sheets and the two switch discs are rotated relative to one another by approximately one half of the pitch with respect to the ring segments.

A rotation of the pole armature effectuates, that one of the two switch discs is magnetized while the other one short circuits the magnetic flow. In this manner magnetizable elements on either side of the pole armature or the two switch discs can be attracted in dependence of the rotational position of the pole armature.

In a preferred embodiment of the invention two switch plates are provided, wherein the switch discs and the pole armature are provided between these switch plates. These switch plates can be used as the above mentioned magnetizable elements, which are attracted in dependence of the rotational position of the pole armature. Preferably the two switch plates are constructed in a identical manner. In this way a symmetric switching can be provided.

In a further preferred embodiment the switch plates can move relative to the switch discs in the direction of the rotation axis of the pole armature. Very preferably the movement of one switch plate is coupled to a movement of the other switch plate.

In a further preferred embodiment return springs are provided which pretension the switch plates. In this way a lose movement of the switch plates can be avoided. Also the switch plates can be forced to a predefined position, ie—an equilibrium position with respect to the switch discs. The return springs may comprise identical or also different spring forces respectively spring constants. Both pressure springs and tension springs may be used.

The invention is furthermore directed to a magnetic storage switch with a pole armature, which can move in a longitudinal direction, with a first switch disc and a second switch disc, wherein the pole armature is provided between these switch discs and wherein the pole armature comprises a plurality of magnets which are arranged next to one another with respectively alternating polarity in the longitudinal direction of the pole armature. According to the invention the switch discs comprise magnetisable segments and the two switch discs are displaced relative to one another in the longitudinal direction by approximately one half of the pitch with respect to the segments.

Whereas the above mentioned embodiment is characterised by a rotational movement of the pole armature, in this case the pole armature is moved along a longitudinal path and preferably a linear path. By virtue of the displacement of the two switch discs with respect to each other also in this case one of the switch discs is magnetised whereas the other one short-circuits the magnetic flow.

### BRIEF DESCRIPTION OF THE DRAWINGS

Further advantages and embodiments of the invention are disclosed in the accompanying drawing. Therein show:

FIG. 1 a schematic view of a first embodiment of the invention;

FIG. 2 a schematic view of a second embodiment of the invention;

FIGS. 3a-3d a schematic view of a first embodiment according to the invention; and

FIG. 4 a characteristic curve of the magnetic flow.

### DETAILED DESCRIPTION OF PREFERRED EMBODIMENTS

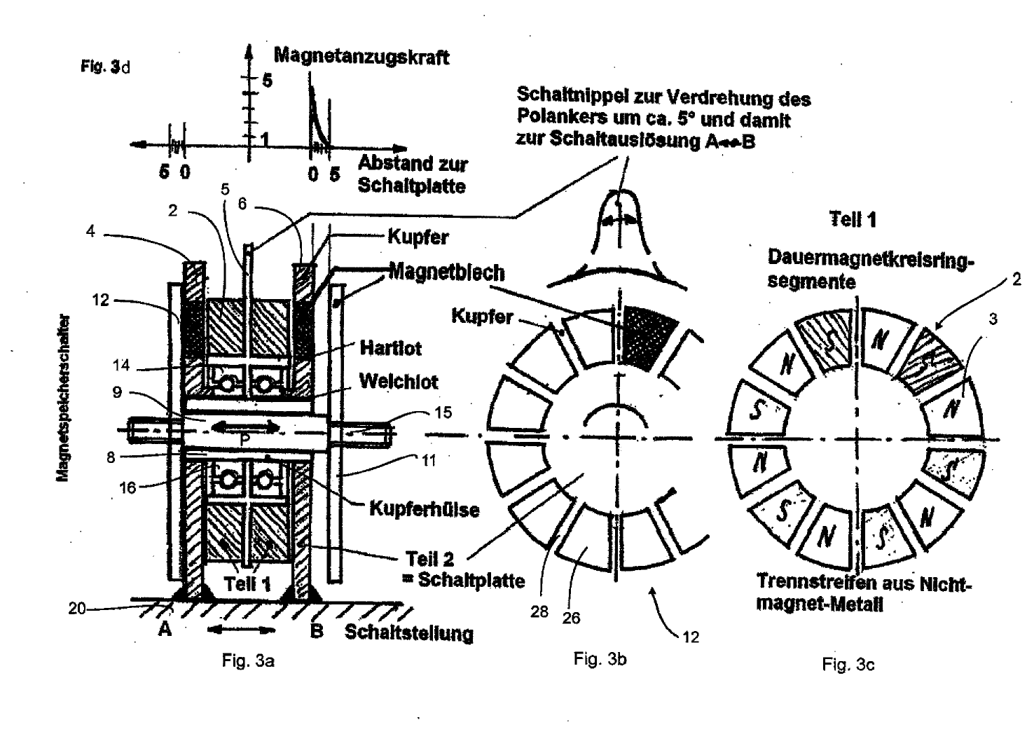

FIGS. 3a-3c show a schematic view of a magnetic storage switch according to the invention. This magnetic storage switch comprises a pole armature 2 (see FIG. 3a), which is rotatable supported around an outer bushing 8 with bearings 14. The pole armature 2 comprises a plurality of permanent magnets 3 with alternating alignment. In the case shown in FIG. 3c the pole armature 2 comprises 12 permanent magnets.

Reference numeral 4 (in the figures also reference symbol A is used) denotes a first switch disc, which is located adjacent to pole armature 3. Another switch disc 6 (also denoted with B in the figures) is located at the other side of the pole armature 3. These switch discs 4 and 6 are located fixed in rotation with respect to the outer bushing 8. Reference numeral 9 denotes another bushing, which is arranged in the interior of the outer bushing 8 and which is movable along arrow P. Reference numeral denotes an axle.

Fixed with respect to this bushing 9 two switch plates 11, 12 are arranged. In dependence of a rotational position of the pole armature either the left switch plate 12 or the right switch plate 12 will me attracted by the pole armature 2 and drawn in the direction of the pole armature 2.

Reference numeral 5 denotes a lever, which is fixedly arranged at the pole armature 3. With this lever the pole armature can be rotated by a certain angle, for example 5 degrees, which leads to a switching of the switch.

FIG. 3b shows a top view of a switch disc 4. This switch disc 12 comprises a plurality of ring segments 26, formed of a magnet sheet. Between two ring segments 26 a plurality of bridges 28 is arranged, wherein these bridges are formed of for example copper. The cross section of the sectors 26 corresponds essentially to the cross section of the permanent magnets 3. In generally, the bridges 28 are formed of a non magnetizable material. Other suitable materials would be glass, plastic, PUR, wood and the like. Also, a carrier could be provided, which separates the ring segments from each other. In this case, there would be a space between the ring segments 26.

The two switch discs 4, 6 shown in FIG. 3a are rotated relative to one another by approximately one half of the pitch with respect to the ring segments 26.

In dependence of a rotational position of the pole armature 2 with respect to the ring segments 26 one of the switch plates 11, 12 will be attracted stronger by the pole armature 2 than the other.

If for example each ring segment 26 of a switch disc 4 covers the permanent magnet 3, respectively its cross section, the magnetic force of the permanent magnets will be transferred to the ring segment 26 of the switch disc.

In this case the bridge 28 made from copper or another non magnetisable material will not influence the magnetic force. This results in an attraction of the respective switch plate 12 by the switch disc 4.

In FIGS. 3a-3c the pole armature has a full cylindrically shape. However the shape of the pole armature may also be a partly cylindrically shape.

If on the other hand, the permanent magnets 3 are between two ring segments 26, a short circuit will appear (i.e. the ring segment 26 will short circuit the magnetic flow) and the respective switch plate will not be attracted by the pole armature. The switch plates 11, 12 may comprise contacting elements (not shown) which in dependence of the position of the switch plates open or close an electric circuit. It is also possible to use the magnetic switch according to the invention to switch other mechanical elements.

Preferably, the pitch of the ring segments 26 equals the pitch of the magnets 3. However, the width of the ring segments 26 in the circumferential direction may also be greater or smaller and especially smaller than that of the magnets 3.

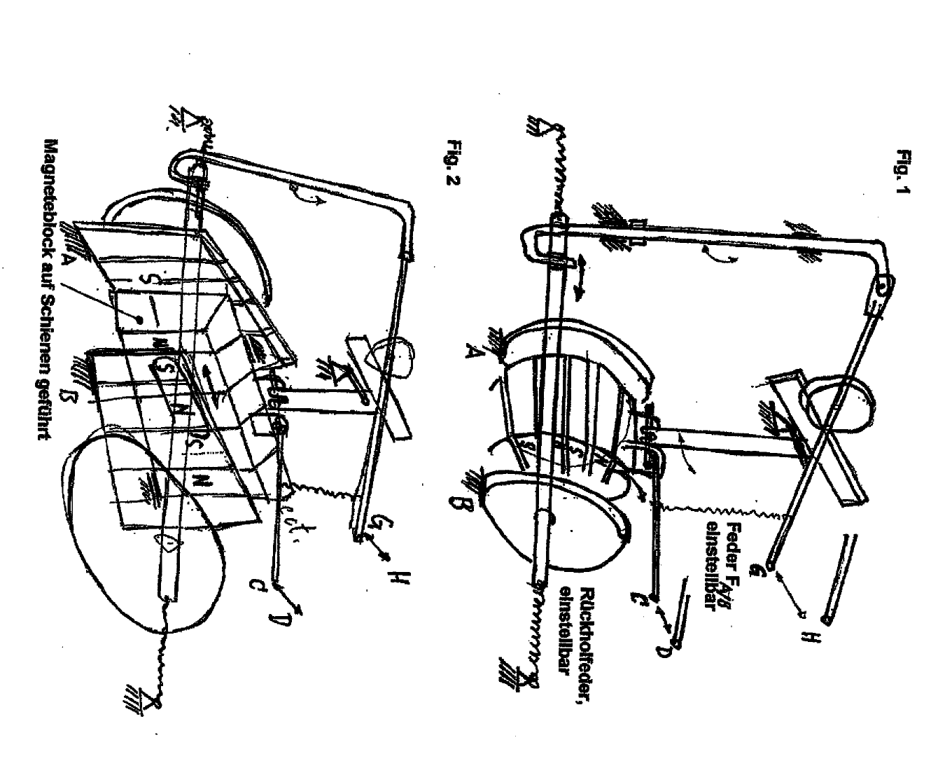

FIG. 2 shows another embodiment of the switch according to the invention. In this case a pole armature is provided, which is movable along a longitudinal path as indicated by the arrow. The switch discs are located on either side of the pole armature. Also, the switch discs A,B are displaced relative to one another in the longitudinal direction by approximately one half of the pitch with respect to the segments. As indicated both in FIG. 1 and in FIG. 2, a elastic spring is provided, which is preferably adjustable and serves to reset the switch plates. Also in the embodiment shown in FIGS. 3a-3d a respective spring may be provided. In FIG. 1 the switch plates, which are fixedly coupled to the bushing 8 respectively the axle shown in FIG. 1, are not shown.

As illustrated in FIG. 3d, only below a distance of 4 mm a usable magnetic force will arise, which will be transferred in an “abundant” attraction force for distances below 2 mm (between the switch discs and the switch plates). This abundant energy is stored in a spring and is used for reducing the activation force (i.e. the rotation of the pole armature). Otherwise for switching the magnet attraction direction in each case the full reminiscence energy would be needed. To reduce the dissipation loss, one part can be saved by storing the energy in springs.

The elastic springs force the switch plates 11, 12 (see FIG. 1) into an equilibrium state or into a position, in which the distance between switch plate 11 and the switch disc 6 essentially equals the distance between the switch plate 12 and the switch disc 4. As mentioned above, the magnetic force will not be sufficient to attract the switch plates at a distance greater than about 4 mm. For certain applications, this distance might not be sufficient.

However, by virtue of this springs, as mentioned above, the distance between the switch discs 4, 6 and the switch plates 11, 12 can be increased, since the springs will force the switch plates back to certain distance. If for example the distance between the two switch plates 11, 12 is 6 mm greater than the distance between the switch discs 4 and 6, the springs can be adjusted to force the switch plates into a symmetrical position with respect to the switch discs. In this case the distance between the switch discs and the switch plates is 3 mm respectively and therefore low enough for magnetic attraction to appear.

With the next switching the force stored in the reset spring adds to the attraction force at a distance of 4 mm or less.

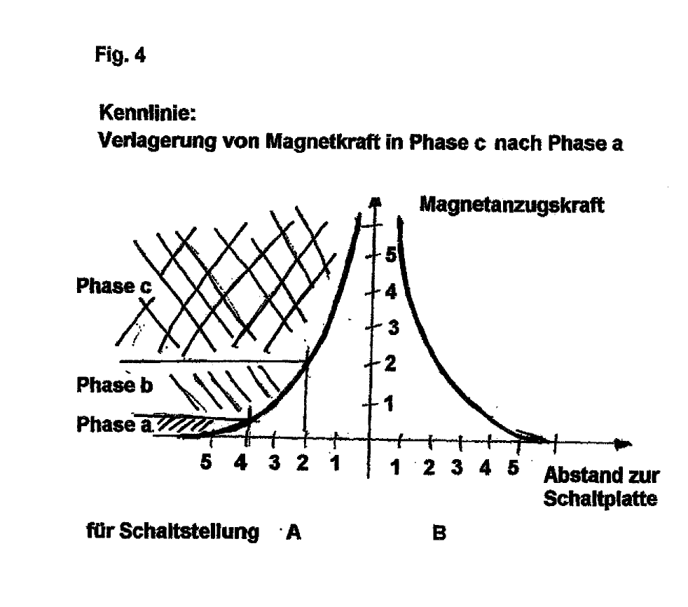

FIG. 4 shows a characteristic curve of the magnetic force in relation to the distance of two elements i.e. A switch disc (A and B) and a switch plate. As can be seen, the magnetic force increases disproportionately for decreasing distances between the switch discs and the respective switch plates. The force of a spring in contrast increases linearly with increasing distance between the switch plates and the switch discs from a certain equilibrium point. Therefore, the magnetic force, which appears at very short distances between the switch plates and the switch discs, is stronger than the elastic force of the spring elements and can therefore partly be saved in the spring element.

Using the lever principle, in switch position A (FIG. 1), the switch lever is displaced from position C to position D, aided by the force F_{A/B}. Once in position D, the magnetic poles in A are short-circuited and in B are released. The magnetic field in B builds up and attracts the switch plate B. At the same time, the lever passes from G to H and in the process prestresses the spring again for the auxiliary force F_{NB} via the magnetic attraction peak in phase c.

Intended use: e.g. as a switch drive in medium-voltage installations.

The intention is to protect the functional principle of a magnetic storage switch
1. characterised by magnetic pole rotation for pole short-circuiting and thus for changing the magnetic attraction direction from switch position A to B and vice versa. see FIGS. 1-4
2. characterised in that the switch discs part 2 (A, B) are rotated relative to one another by approximately one half of the pitch.
3. characterised by the rotary arrangement and functional principle (see FIG. 1), but also by the translatory arrangement (FIG. 2) and the functional principle thereof for displacing the magnetic poles relative to one another, for switching purposes.
4. but also characterised by a translatory arrangement in which the switch faces are displaced relative to one another by approximately one half of the pitch.
5. characterised by the shifting of the magnetic attraction peaks (FIG. 4) from phase c to phase a in general, and in particular the shifting of the magnetic force peaks via said lever principle.

### KEY TO FIGURES

| GERMAN | ENGLISH |
|---|---|
| Magnetspeicherschalter | Magnetic storage switch |
| Feder F_{A/B} einstellbar | Spring F_{A/B}, adjustable |
| Rückholfeder, einstellbar | Return spring, adjustable |
| Magneteblock auf Schienen | Magnet block guided on rails |
| geführt | |
| Magnetanzugskraft | Magnetic attraction force |
| Abstand zur Schaltplatte | Distance from switch plate |
| Kupfer | Copper |
| Magnetblech | Magnetic sheet |
| Hartlot | Hard solder |
| Weichlot | Soft solder |
| Kupferhülse | Copper sleeve |
| Teil 2 = Schaltplatte | Part 2 = switch plate |
| Teil 1 | Part 1 |
| Schaltstellung | Switch position |
| Schaltnippel zur Verdrehung | Switch nipple for rotating the pole |
| des Polankers um ca. 5° und damit | armature by approx. 5° and thus for |
| zur Schaltauslösung A-B | triggering the switch A-B |
| Dauermagnetkreisringsegmente | Permanent magnet ring segments |
| Trennstreifen aus Nicht- | Separating strips of non-magnetic |
| magnet-Metall | metal |
| Kennlinie: | Curve: |
| Verlagerung von Magnetkraft | Shift of magnetic force in phase c to |
| in Phase c nach Phase a | phase a |
| für Schaltstellung | for switch position |

1. Magnetic storage switch with a pole armature which can be rotated about an axis, a first switch disc (A) and a second switch disc (B), wherein the pole armature is provided between these switch discs (A, B) and the pole armature comprises a plurality of magnets which are arranged with respectively alternating polarity in the circumferential direction of the pole armature, characterised in that the switch discs (A, B) comprise magnetisable ring segments in the form of magnetic sheets and the two switch discs (A, B) are rotated relative to one another by approximately one half of the pitch with respect to the ring segments.

2. Magnetic storage switch according to claim 1, characterised in that two switch plates are provided, wherein the switch discs (A, B) and the pole armature are provided between these switch plates.

3. Magnetic storage switch according to claim 1 characterised in that the switch plates can move relative to the switch discs (A, B) in the direction of the rotation axis of the pole armature.

4. Magnetic storage switch according to claim 2, characterised in that return springs are provided which pretension the switch plates.

5. Magnetic storage switch with a pole armature which can move in a longitudinal direction, with a first switch disc (A) and a second switch disc (B), wherein the pole armature is provided between these switch discs (A, B) and the pole armature comprises a plurality of magnets which are arranged next to one another with respectively alternating polarity in the longitudinal direction of the pole armature, characterised in that the switch discs (A, B) comprise magnetisable segments and the two switch discs (A, B) are displaced relative to one another in the longitudinal direction by approximately one half of the pitch with respect to the segments.
